(19) United States
(12) Patent Application Publication
(10) Pub. No.: US 2002/0047689 A1
(43) Pub. Date: Apr. 25, 2002

(54) Engine generator system

(76) Inventors: Shuji Bessho, Nitta-gun (JP); Michihiro Iida, Wako-shi (JP); Shinya Fuse, Wako-shi (JP)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/957,452

(22) Filed: Sep. 21, 2001

(30) Foreign Application Priority Data
Sep. 21, 2000 (JP) 2000-291975

(51) Int. Cl. H02P 9/04

(52) U.S. Cl. 322/1; 290/1 A

(57) ABSTRACT

An engine generator system in which an exhaust muffler mounted on a frame in an engine area is disposed above a portion of a generator with an upper portion of a heat shield plate interposed between the muffler and a fuel tank. A battery is mounted on a battery base and disposed in the engine area with a heat shield plate 26 interposed between the battery and a control box. A battery cover partitions off the battery and the muffler from each other is fastened to the heat shield plate and the battery base at a location displaced sideways from the battery. Harnesses pass through grommets mounted on the battery cover, individually corresponding to plus and minus terminals. Thus, the battery can be mounted on the frame while preventing an increase in size of the system and to prevent the wiring from being complicated. Moreover, an adverse effect to the battery due to heat from the muffler can be prevented.

### BACKGROUND OF THE INVENTION

1. Field of the Invention

The present invention relates to an engine generator system and particularly, to an improvement in an engine generator system comprising a generator, a fuel tank and a control box, which are mounted on a frame in a generator area, an engine mounted on the frame in an engine area portioned from the generator area by a heat shield plate secured to the frame, and an exhaust muffler of the engine disposed above a portion of the generator at a location where an upper portion of the heat shield plate is interposed between the exhaust muffler and the fuel tank.

2. Description of the Related Art

Such an engine generator system is conventionally known from Japanese Patent Application Laid-open No.10-89083.

In the engine generator system disclosed in the above Patent Application, the exhaust muffler can be disposed at a location near the fuel tank by interposition of the heat shield plate between the exhaust muffler and the fuel tank, wiring to an increased freedom degree of disposition of the engine.

In such engine generator system, it is desired that when the battery is mounted on the frame, an increase in size of the entire engine generator system due to the mounting of the battery is avoided, and the wiring of electric cords connected to the battery is prevented from being complicated.

### SUMMARY OF THE INVENTION

Accordingly, it is an object of the present invention to provide an engine generator system including a battery mounted on a frame, wherein an increase in size of the system is avoided, and the wiring of the electric cords is prevented from being complicated and moreover, an adverse effect due to heat radiated from an exhaust muffler is prevented from being exerted to the battery.

To achieve the above object, according to the present invention, there is provided an engine generator system comprising a heat shield plate secured to a frame and extending vertically to divide the inside of said frame into a generator area and an engine area; a generator having a portion passed through a lower portion of said heat shield plate to protrude into said engine area; a fuel tank disposed above said generator; a control box disposed sideways of said generator; said generator, said fuel tank and said control box being mounted on said frame; an engine mounted on said frame in said engine area for driving said generator; and an exhaust muffler of said engine, the exhaust muffler being disposed above the portion of said generator disposed in said engine area and in such a manner that an upper portion of said heat shield plate is interposed between said exhaust muffler and said fuel tank, wherein the engine generator system further includes a battery which is mounted on a battery base fixed to said frame and which is disposed sideways of the portion of said generator disposed in said engine area and in such a manner that a lower portion of said heat shield plate is interposed between said battery and said control box, a battery cover which is fastened to said heat shield plate and to said battery base at a location displaced sideways from said battery on the side opposite from said heat shield plate and which partitions off said battery and said exhaust muffler from each other, said battery cover is provided with a pair of through-bores individually corresponding to plus and minus terminals of said battery, and a pair of harnesses passed through grommets mounted in said through-bores and connected to said plus and minus terminals, respectively.

With such arrangement, the battery mounted on the battery base fixed to the frame is disposed in a space produced sideways of the portion of the generator protruding into the engine area, i.e., in a space adjoining the control box with the lower portion of the heat shield plate interposed therebetween. Thus, it is possible to prevent an increase in size of the engine generator system without need for newly ensuring a space for mounting of the battery, while simplifying the wiring of electric cords between the battery and engine and between the battery and the control box. There is a possibility that heat radiated from the exhaust muffler disposed above the portion of the generator protruding into the engine area exerts an adverse effect to the battery. However, the battery and the exhaust muffler are partitioned off by the battery cover, and hence, the temperature of the battery cannot be raised excessively and can be maintained at an appropriate level. In addition, the battery cover is fastened to the heat shield plate and also to the battery base at the location displaced sideways of the battery on the side opposite from the heat shield plate. Therefore, the battery cover can be supported and fixed, so that the fluttering of the battery cover is not generated due to the vibration caused with the operations of the engine and the generator. Moreover, the position of fastening of the battery cover to the battery base is set at the position displaced sideways from the battery on the battery base and hence, it is possible to reliably prevent a fastening bolt from being brought into contact with the battery by the vibration. Further, the pair of through-bores individually corresponding to the plus and minus terminals of the battery are provided in the battery cover, and the pair of harnesses passed through the grommets mounted in the through-bores are connected to the plus and minus terminals, respectively. Therefore, it is possible to prevent the occurrence of misconnection between the plus and minus terminals and the harnesses. Further, it is possible to prevent the harnesses from being damaged due to the contact with the battery cover by the grommets, and to prevent radiant heat from the exhaust muffler from flowing toward the battery through portions of the battery cover through which the harnesses are passed.

The above and other objects, features and advantages of the invention will become apparent from the following description of the preferred embodiment taken in conjunction with the accompanying drawings.

### BRIEF DESCRIPTION OF THE DRAWINGS

FIG. 1 is a side view of an engine generator system according to an embodiment of the present invention;

FIG. 2 is a partially cutaway plan view taken in a direction of an arrow 2 in FIG. 1;

FIG. 3 is a sectional view taken along a line 3-3 in FIG. 1; and

FIG. 4 is a perspective view of a battery cover.

### DESCRIPTION OF THE PREFERRED EMBODIMENT

The present invention will now be described by way of an embodiment with reference to the accompanying drawings.

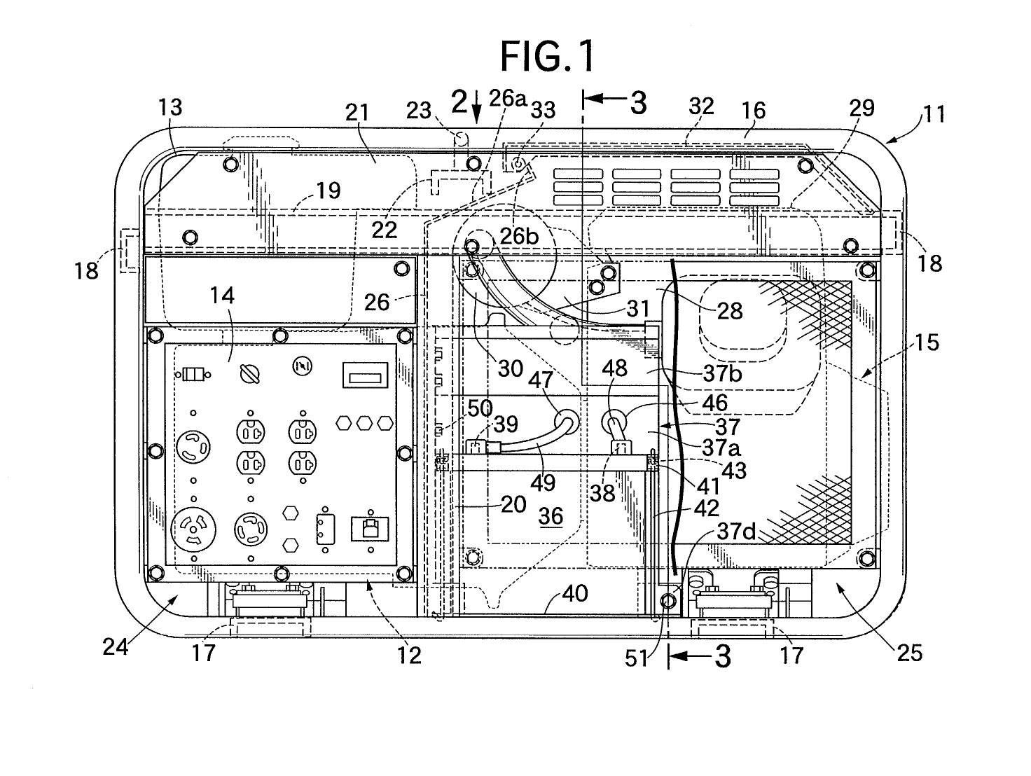

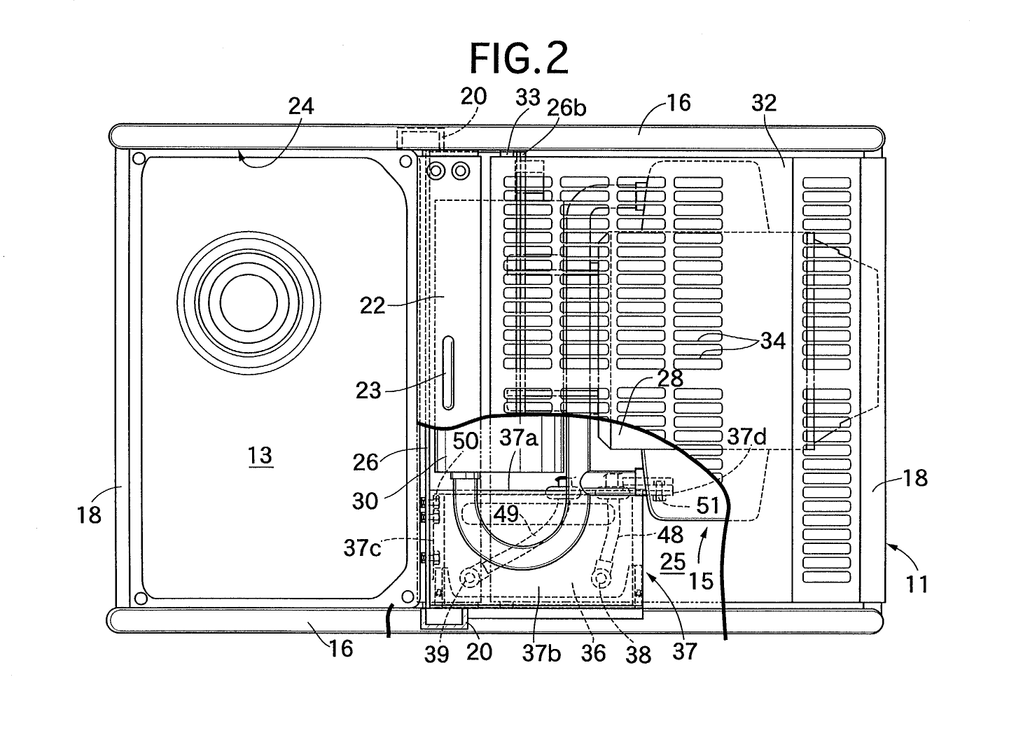

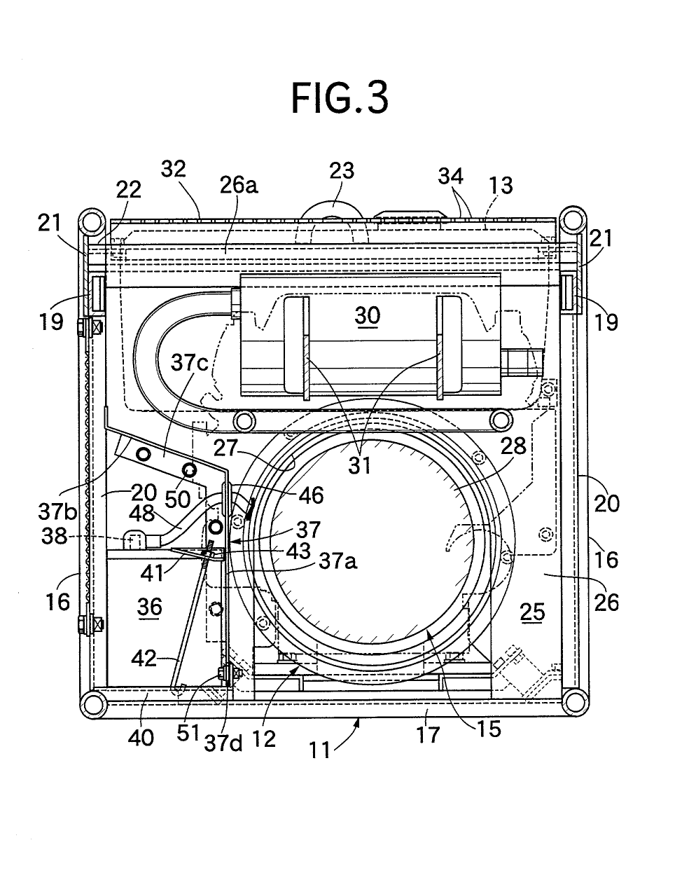

Referring first to FIGS. 1 to 3, an engine generator system comprises a generator 1, a fuel tank 13, control box 14, an engine 15 and the like, which are mounted on a frame 11.

The frame 11 includes a pair of left and right pipe frames 16, 16 formed into a substantially quadrilateral shape by bending a rounded pipe, a pair of front and rear lower cross frames 17, 17 connecting lower portions of the pipe frames 16, 16 to each other, a pair of front and rear upper cross frames 18, 18 connecting upper portions of the pipe frames 16, 16 to each other, a pair of left and right lateral frames 19, 19 connecting the upper portions of the pipe frames 16, 16 to each other, a pair of left and right vertical frames 20, 20 connecting intermediate portions of the lateral frames 19, 19 and the lower portions of the pipe frames 16, 16 to each other, frame plates 21, 21 mounted between the lateral frames 19, 19 and the upper portions of the pipe frames 16, 16, and a center cross frame 22 connected to the lateral frames 19, 19 halfway between the upper cross frames 18, 18.

A substantially U-shaped hanger 23 is secured to an upper surface of a lengthwise central portion of the center cross frame 22 for hanging the entire engine generator system using a hoist or the like and placing it on a carriage or the like.

A heat shield plate 26 is secured to the frame 11 at a location substantially corresponding to the center cross frame 22, and extends vertically to divide the inside of the frame 11 into a generator area 24 and an engine area 25.

The fuel tank 13 disposed above the generator 12 and the control box 14 disposed sideways of the generator 12 are mounted on the frame 11 in the generator area 24. A portion of the generator 12 is passed through an opening 27 provided at a lower portion of the heat shield plate 26 to protrude into the engine area 25.

The engine 15 is mounted on the frame 11 in the engine area 25 and includes an engine body 28, an air cleaner 29 disposed at an upper portion of the engine body 28 and constituting a portion of an intake system, an exhaust muffler 30 constituting a portion of an exhaust system, and the like. A power from a crankshaft (not shown) of the engine body 28 is transmitted to the portion of the generator 12 protruding into the engine area 25.

The exhaust muffler 30 included in the engine 15 is supported on a bracket 31 mounted on the engine body 28 and disposed above a portion of the generator 12 disposed in the engine area 25 and at a location where an upper portion of the heat shield plate 26 is interposed between the exhaust muffler 30 and the fuel tank 13.

The heat shield plate 26 is provided at its upper portion with an inclined plate portion 26a which is disposed between the exhaust muffler 30 and the center cross frame 22 and inclined upwards in a rearward direction. A stopper 26b is connected at a substantially right angle to an upper end of the inclined plate portion 26a to extend slightly forwards and upwards.

A cover 32 is turnably supported at its base end on the frame 11 at a location corresponding to the upper end of the heat shield plate 26 by support shafts 33 to openably and closably cover the above of the engine 15, and a large number of openings 34 are provided in the cover 32. Thus, the cover 32 is turnable between a fully closed position in which it covers the above of the engine 15, and a fully opened position in which it opens the above of the engine 15. However, the base end of the cover 32 in the fully opened position can be brought into engagement with the stopper 26b provided at the upper end of the heat shield plate 26, whereby the fully opened position of the cover 32 can be maintained.

A battery base 40 is fixed to a lower portion of the frame 11 sideways of the portion of the generator 12 disposed in the engine area 25 and at a location where the lower portion of the heat shield plate 26 is interposed between the battery base 40 and the control box 14. A battery 36 is placed on the battery base 40 and has a plus terminal 38 and a minus terminal 39 on its upper surface.

Stays 42 are swingably engaged at their lower portions with the battery base 40 on opposite sides of the battery 36. Nuts 43 engaged with an upper surface of a presser plate 41 are threadedly fitted over upper portions of the stays 42, so that the battery 36 is mounted on the battery base 40 by tightening the nuts 43. Moreover, the presser plate 41 is disposed, so that it is brought into contact with the upper surface of the battery 36 inside the plus and minus terminals 38 and 39 in a state in which the battery 36 is on the battery base 40, in order to avoid that a tool such as a spanner is brought into contact with the terminal included in the battery 36, particularly, the plus terminal 38 to cause a short-circuiting.

On the other hand, the exhaust muffler 30 of the engine 15 is disposed above the portion of the generator 12 disposed in the engine area 25 and hence, there is a possibility that heat radiated from the exhaust muffler 30 exerts an adverse effect to the battery 36.

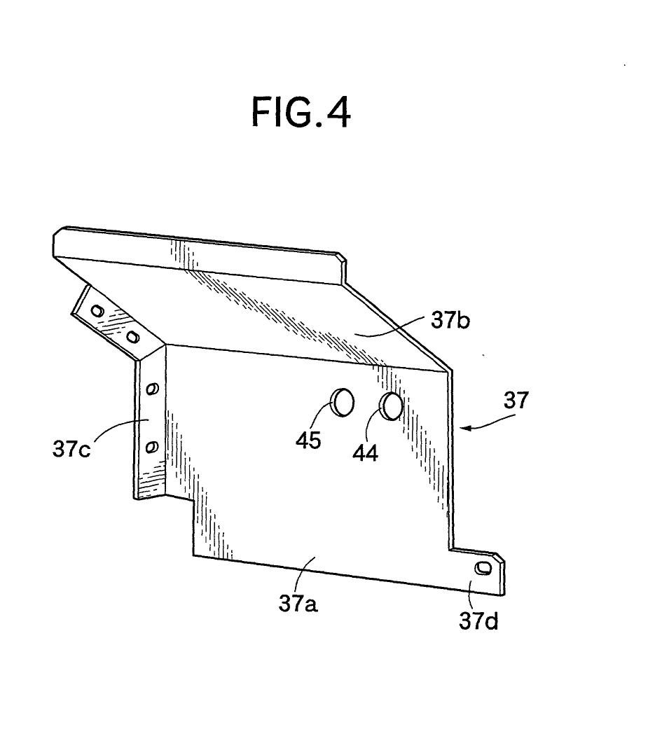

To avoid such possibility, a battery cover 37 made of a metal and shown in FIG.4 is fixed to the frame 11, so that it is interposed between the battery 36 and the exhaust muffler 30.

The battery cover 37 includes an upright plate portion 37a interposed between the portion of the generator 25 disposed in the engine area 25 and the battery 36, a canopy portion 37b connected to an upper portion of the upright plate portion 37a to cover the battery 36 from the above, a side-plate portion 37c connected at a right angle to side edges of the upright plate portion 37a and the canopy portion 37b, and a protrusion plate portion 37d protruding sideways from a lower portion of the upright plate portion 37a on the side opposite from the side-plate portion 37c.

The side-plate portion 37c is fastened to the lower portion of the heat shield plate 26 by a plurality of bolts 50, and the protrusion plate portion 37d is fastened to the battery base 40 by a bolt 51 at a location displaced sideways from the battery 36 on the battery base 40 on the side opposite from the heat shield plate 26, whereby the battery cover 37 is fixed to the frame 11.

Moreover, the canopy portion 37b covering the battery 36 is formed, so that it is inclined with its level higher at a location more spaced apart from the upright plate portion 37a. By inclining the canopy portion 37b in the above manner, the spacing between the battery 36 and the canopy portion 37b can be set at a large value to the utmost, and it is possible to avoid, to the utmost, that the influence due to heat radiated from the canopy portion 37b by heating by the heat radiated from the exhaust muffler 30 is exerted to the battery 36. Moreover, it is possible to avoid that a tool such as a spanner is brought into contact with the canopy 37b, when an operation for connecting an electric cord to the battery 36 is carried out.

As best shown in FIG. 4, two through-bores 44 and 45 are provided in the upright plate portion 37a of the battery cover 37 in an arrangement corresponding to the plus and minus terminals 38 and 39 of the battery 36.

Grommets 46 and 47 made of an elastomer material such as rubber are mounted in the through-bores 44 and 45 in the battery cover 37, respectively, and a pair of harnesses 48 and 49 extending through the grommets 46 and 47 are connected to the plus and minus terminals 38 and 39 of the battery 36, respectively.

The operation of the embodiment will be described below. To mount the battery 36 on the frame 11, the battery 36 is placed on the battery base 40 fixed to the frame 11 sideways of the portion of the generator 12 disposed in the engine area 25 and at the location where the lower portion of the heat shield plate 26 is interposed between the battery base 40 and the control box 14. Therefore, the battery 36 is disposed in a space created sideways of the portion of the generator 12 protruding into the engine area 25, i.e., in a space adjoining the control box 14 with the lower portion of the heat shield plate 26 interposed therebetween. Thus, it is possible to prevent an increase in size of the engine generator system without need for newly ensuring a space for mounting of the battery 36, while simplifying the wiring of electric cords between the battery 36 and the engine 15 and between the battery 36 and the control box 14.

Since the exhaust muffler 30 is disposed above the portion of the generator 12 protruding into the engine area 25, there is a possibility that the heat radiated from the exhaust muffler 30 exerts an adverse effect to the battery 36. However, the battery 36 and the exhaust muffler 30 are partitioned off by the battery cover 37 and hence, the temperature of the battery 30 cannot be raised excessively, and is maintained at an appropriate level where, for example, the temperature rise is equal to or lower than 25°.

In addition, since the battery cover 37 is fastened to the heat shield plate 26 and also to the battery base 40 at the location displaced sideways from the battery 36 on the side opposite from the heat shield plate 26, the battery cover 37 can be supported and fixed, so that the fluttering of the battery cover 37 cannot be produced by the vibration generated with the operations of the engine 15 and the generator 12. Moreover, the position of fastening of the battery cover 37 to the battery base 40 is set at the position displaced sideways from the battery 36 on the battery base 40 and hence, it is possible to reliably prevent the fastening bolt 51 from being brought into contact with the battery 36 by the vibration and to reliably prevent a housing made of a synthetic resin and included in the battery 36 from being flawed or scratched due to the contact with the bolt 51.

Further, the pair of through-bores 44 and 45 corresponding to the plus and minus terminals 38 and 39 of the battery 36 are provided in the upright plate portion 37a of the battery cover 37, and the pair of harnesses 48 and 49 extending through the grommets 46 and 47 mounted respectively in the through-bores 44 and 45 are connected to the plus and minus terminals 38 and 39, respectively. Therefore, it is possible to prevent the occurrence of the misconnection between the plus and minus terminals 38 and 39 and the harnesses 48 and 49. Moreover, it is possible to prevent the harnesses 48 and 49 from being damaged due to the contact with the battery cover 37 by the grommets 46 and 47, and to prevent hot air from the exhaust muffler from flowing toward the battery 36 through portions of the battery cover 37 through which the harnesses are passed.

Although the embodiments of the present invention have been described in detail, it will be understood that the present invention is not limited to the above-described embodiments, and various modifications in design may be made without departing from the spirit and scope of the claims.

What is claimed is:

1. An engine generator system comprising a heat shield plate secured to a frame and extending vertically to divide the inside of said frame into a generator area and an engine area; a generator having a portion passed through a lower portion of said heat shield plate to protrude into said engine area; a fuel tank disposed above said generator; a control box disposed sideways of said generator; said generator, said fuel tank and said control box being mounted on said frame; an engine mounted on said frame in said engine area for driving said generator; and an exhaust muffler of said engine, the exhaust muffler being disposed above the portion of said generator disposed in said engine area and in such a manner that an upper portion of said heat shield plate is interposed between said exhaust muffler and said fuel tank, wherein the engine generator system further includes a battery which is mounted on a battery base fixed to said frame and which is disposed sideways of the portion of said generator disposed in said engine area and in such a manner that a lower portion of said heat shield plate is interposed between said battery and said control box, a battery cover which is fastened to said heat shield plate and to said battery base at a location displaced sideways from said battery on the side opposite from said heat shield plate and which partitions off said battery and said exhaust muffler from each other, said battery cover is provided with a pair of through-bores individually corresponding to plus and minus terminals of said battery, and a pair of harnesses passed through grommets mounted in said through-bores and connected to said plus and minus terminals, respectively.
